(19) United States
(12) Patent Application Publication
(10) Pub. No.: US 2025/0208418 A1
(43) Pub. Date: Jun. 26, 2025

(54) OPTICAL ELEMENT, LASER MODULE, RETINAL PROJECTION DEVICE, AND NEAR-EYE WEARABLE DEVICE

(71) Applicant: TDK Corporation, Tokyo (JP)

(72) Inventors: Atsushi SHIMURA, Tokyo (JP); Yasuhiro TAKAGI, Tokyo (JP); Hiroki HARA, Tokyo (JP)

(73) Assignee: TDK Corporation, Tokyo (JP)

(21) Appl. No.: 18/830,794

(22) Filed: Sep. 11, 2024

(30) Foreign Application Priority Data
Dec. 20, 2023 (JP) 2023-214718

(51) Int. Cl. G02B 27/01; G02F 1/01

(52) U.S. Cl. CPC G02B 27/0172; G02F 1/011; G02F 1/0136; G02B 2027/0178

(57) ABSTRACT

An optical element includes: a substrate including a main surface; a core layer provided on the main surface and made of a material having an electro-optic effect, the core layer including a waveguide extending in a first direction along the main surface; and a metal body extending in the first direction and provided in parallel with the waveguide. The waveguide and the metal body constitute a mode converter that converts a polarization mode of visible light from a first polarization mode, which is one polarization mode among a TE mode and a TM mode, to a second polarization mode, which is another polarization mode among the TE mode and the TM mode. The metal body includes an edge in a second direction intersecting the first direction and along the main surface. The edge overlaps the waveguide when viewed from a third direction intersecting the main surface.

### CROSS-REFERENCE TO RELATED APPLICATION

This application claims the benefit of priority from Japanese Patent Application No. 2023-214718 filed with the Japan Patent Office on Dec. 20, 2023, the entire contents of which are incorporated herein by reference.

### TECHNICAL FIELD

The present disclosure relates to an optical element, a laser module, a retinal projection device, and a near-eye wearable device.

### BACKGROUND

The polarization mode of light propagating through the optical waveguide includes a transverse electric (TE) mode, which is a polarization mode having a main electric field in a direction parallel to the substrate, and a transverse magnetic (TM) mode, which is a polarization mode having a main electric field in a direction perpendicular to the substrate. An optical element for converting these polarization modes is known. For example, Non-Patent Document 1 (Shinmo An and O-Kyun Kwon, Integrated InP polarization rotator using the plasmonic effect, Optics Express, 2018, Vol. 26, No. 2, pp. 1305-1314) describes a polarization rotator including an InGaAsP ridge waveguide provided on an InP material and a metal layer provided on an upper cladding.

### SUMMARY

The polarization rotator described in Non-Patent Document 1 converts the polarization mode of light having a wavelength of 1.55 μm. However, no consideration is given to visible light.

The present disclosure describes an optical element, a laser module, a retinal projection device, and a near-eye wearable device capable of converting a polarization mode of visible light.

An optical element according to one aspect of the present disclosure includes: a substrate including a main surface; a core layer provided on the main surface and made of a material having an electro-optic effect, the core layer including a waveguide extending in a first direction along the main surface; and a metal body extending in the first direction and provided in parallel with the waveguide. The waveguide and the metal body constitute a mode converter that converts a polarization mode of visible light from a first polarization mode, which is one polarization mode among a TE mode and a TM mode, to a second polarization mode, which is another polarization mode among the TE mode and the TM mode. The waveguide includes an incident end on which the visible light in the first polarization mode is incident and an emission end from which the visible light in the second polarization mode is emitted. The metal body includes an edge in a second direction intersecting the first direction and along the main surface. The edge overlaps the waveguide when viewed from a third direction intersecting the main surface.

In the optical element, the waveguide and the metal body are provided in parallel, and the edge of the metal body in the second direction overlaps the waveguide when viewed from the third direction. Since the metal body has a negative dielectric constant, surface plasmons are excited on the surface of the metal body. Therefore, the polarization mode of the visible light propagating through the waveguide interacts with the surface plasmons, and is rotated in accordance with the position of the edge of the metal body. As a result, the first mixed mode and the second mixed mode in which the TE mode and the TM mode are mixed can be generated in the portion of the waveguide parallel to the metal body. Since there is a difference between the propagation constant of the first mixed mode and the propagation constant of the second mixed mode, a phase difference occurs between the phase of the first mixed mode and the phase of the second mixed mode in accordance with the length of the above-described portion. When the visible light is emitted from the above-described portion, the first mixed mode and the second mixed mode are coupled into a single mode, and the polarization mode of the visible light can be converted from the first polarization mode to the second polarization mode. As described above, according to the optical element, the polarization mode of the visible light can be converted.

The waveguide may include a bottom surface facing the main surface and a top surface provided opposite to the bottom surface in the third direction. The metal body may be disposed such that the edge, the top surface, and the bottom surface are arranged in that order in the third direction. In this case, since the rotation angle between the optical axis of the mixed mode and the plane parallel to the main surface of the substrate can be made close to 45°, the conversion efficiency can be improved.

A distance in the second direction between a center of the waveguide in the second direction and the edge may be 0 nm or more and half or less of a length of the waveguide in the second direction. In this case, since the rotation angle between the optical axis of the mixed mode and the plane parallel to the main surface of the substrate can be made close to 45°, the conversion efficiency can be improved.

The metal body may be made of a metal containing at least one element selected from a group consisting of silver, gold, copper, aluminum, chromium, manganese, titanium, vanadium, iron, cobalt, nickel, zinc, molybdenum, palladium, tantalum, tungsten, platinum, lead, and bismuth.

The above-described optical element may include: a first mode converter which is the mode converter that converts a polarization mode of red light from the first polarization mode to the second polarization mode; a second mode converter which is the mode converter that converts a polarization mode of green light from the first polarization mode to the second polarization mode; a third mode converter which is the mode converter that converts a polarization mode of blue light from the first polarization mode to the second polarization mode; and a multiplexer that multiplexes the red light, the green light, and the blue light to emit laser light. According to this configuration, the polarization mode of the red light is converted from the first polarization mode to the second polarization mode, the polarization mode of the green light is converted from the first polarization mode to the second polarization mode, and the polarization mode of the blue light is converted from the first polarization mode to the second polarization mode. By using a polarization mode with the highest multiplexing efficiency in the multiplexer, selected from the TM mode and the TE mode, as the second polarization mode, the multiplexing efficiency can be improved.

A length of the waveguide of the first mode converter in the third direction, a length of the waveguide of the second mode converter in the third direction, and a length of the waveguide of the third mode converter in the third direction may be equal to each other. According to this configuration, the waveguide of the first mode converter, the waveguide of the second mode converter, and the waveguide of the third mode converter can be formed on the same substrate, and the length of each waveguide in the third direction can be made the same, so that the manufacture of the optical element can be facilitated.

The above-described optical element may further include: a first modulator that modulates light intensity of the red light; a second modulator that modulates light intensity of the green light; and a third modulator that modulates light intensity of the blue light. In order to output full-color laser light by multiplexing the red light, the green light, and the blue light, it is necessary to adjust the light intensity of light of each color corresponding to the color to be output. According to the above configuration, since the light intensity of the red light, the light intensity of the green light, and the light intensity of the blue light are modulated by the modulators, it is possible to output full-color laser light without requiring a large drive current.

A laser module according to another aspect of the present disclosure includes: the above-described optical element; a first light source that emits the red light in the first polarization mode; a second light source that emits the green light in the first polarization mode; and a third light source that emits the blue light in the first polarization mode. Since the laser module includes the above-described optical element, the polarization modes of the red light, the green light, and the blue light can be converted.

A retinal projection device according to still another aspect of the present disclosure is a device mounted on a near-eye wearable device. The retinal projection device includes: the above-described laser module; a movable mirror that performs scanning with the laser light emitted from the laser module; and a reflector that projects an image onto a retina of a user wearing the near-eye wearable device by reflecting the laser light having passed through the movable mirror and irradiating the retina with reflected light. The retinal projection device includes the above-described optical element. Accordingly, in the retinal projection device, it is possible to project an image onto the retina after converting the polarization modes of the red light, the green light, and the blue light.

A near-eye wearable device according to still another aspect of the present disclosure includes: the above-described retinal projection device; and a lens provided with the reflector. The near-eye wearable device includes the above-described optical element. Accordingly, in the near-eye wearable device, it is possible to project an image onto the retina after converting the polarization modes of the red light, the green light, and the blue light.

According to each aspect and each embodiment of the present disclosure, the polarization mode of visible light can be converted.

### BRIEF DESCRIPTION OF THE DRAWINGS

FIG. 1 is a perspective view showing an appearance of a near-eye wearable device to which a laser module according to an embodiment is applied.

FIG. 2 is a configuration diagram schematically showing the retinal projection device shown in FIG. 1.

FIG. 3 is a block diagram of the laser module shown in FIG. 2.

FIG. 4 is a perspective view showing the configuration of the mode converter shown in FIG. 3.

FIG. 5 is a cross-sectional view taken along the line V-V of FIG. 4.

FIG. 6 is a cross-sectional view taken along the line VI-VI of FIG. 4.

FIG. 7 is a diagram for explaining the conversion principle of the mode converter shown in FIG. 4.

FIG. 8 is a graph showing an example of the conversion efficiency in the mode converter shown in FIG. 4.

FIG. 9 is a block diagram of a laser module according to another embodiment.

FIG. 10 is a block diagram of a laser module according to still another embodiment.

FIG. 11 is a block diagram of a laser module according to still another embodiment.

FIG. 12 is a diagram showing the relationship between the conversion length and the conversion efficiency in the mode converter of Example 1.

FIG. 13 is a diagram showing the relationship between the conversion length and the conversion efficiency in the mode converter of Example 2.

FIG. 14 is a diagram showing the relationship between the conversion length and the conversion efficiency in the mode converter of Example 3.

FIG. 15 is a diagram showing calculation results of conversion loss of red light.

FIG. 16 is a diagram showing calculation results of conversion loss of green light.

FIG. 17 is a diagram showing calculation results of conversion loss of blue light.

FIG. 18 is a diagram showing the relationship between the distance between the waveguide and the metal body in the Z-axis direction and the conversion loss.

### DETAILED DESCRIPTION

Hereinafter, embodiments of the present disclosure will be described in detail with reference to the drawings. In the description of the drawings, the same elements are denoted by the same reference numerals, and redundant description will be omitted. In each figure, an XYZ coordinate system may be shown. The Y-axis direction (second direction) is a direction intersecting (for example, orthogonal to) the X-axis direction (first direction) and the Z-axis direction (third direction). The Z-axis direction is a direction intersecting (for example, orthogonal to) the X-axis direction and the Y-axis direction. In the present specification, the numerical ranges indicated by “to” represent ranges that include the values described before and after “to” as the minimum and maximum values, respectively. The individually described upper and lower limit values can be combined arbitrarily.

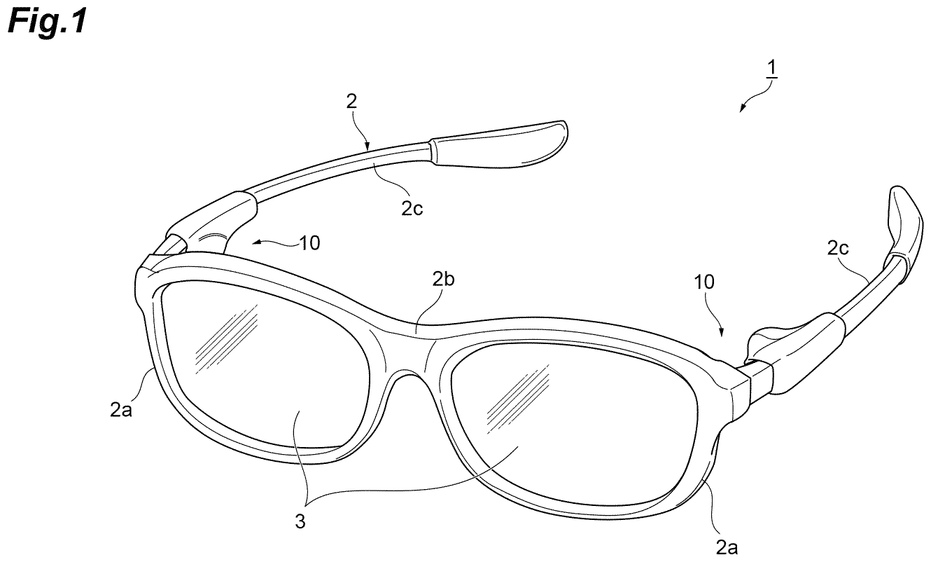

An application example of a laser module according to an embodiment will be described with reference to FIG. 1. FIG. 1 is a perspective view showing an appearance of a near-eye wearable device to which a laser module according to an embodiment is applied. The near-eye wearable device 1 shown in FIG. 1 is a device that projects images onto the retina of a user wearing the near-eye wearable device 1. The near-eye wearable device 1 is, for example, a head-mounted device, and may take the form of an eyeglass type, a goggle type, a hat type, a helmet type, or the like. Examples of the near-eye wearable device 1 include smart glasses such as augmented reality (AR) glasses, virtual reality (VR) glasses, and mixed reality (MR) glasses. The near-eye wearable device 1 includes a frame 2, a lens 3, and a retinal projection device 10.

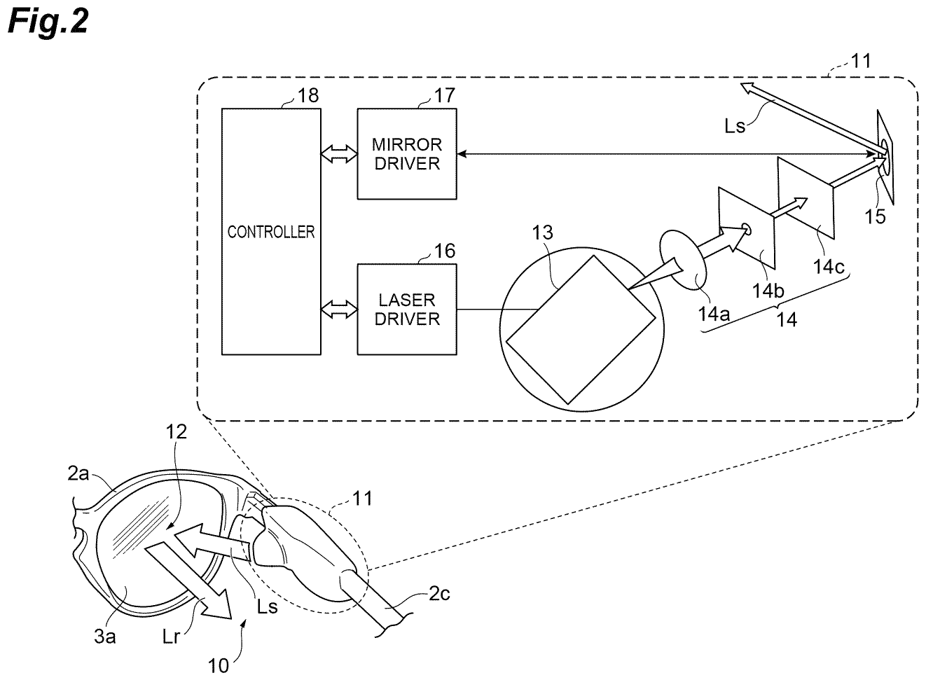

The frame 2 includes a pair of rims 2a, a bridge 2b, and a pair of temples 2c. The rim 2a is a portion for holding the lens 3. The bridge 2b is a portion connecting the pair of rims 2a. The temple 2c extends from the rim 2a and is a portion to be put on an ear of a user. The frame 2 may be a rimless frame. The lens 3 has an inner surface 3a (refer to FIG. 2) facing an eyeball of a user wearing the near-eye wearable device 1.

The retinal projection device 10 is a device for directly projecting (drawing) an image onto a retina of a user wearing the near-eye wearable device 1. The retinal projection device 10 is mounted on the near-eye wearable device 1. In the present embodiment, the near-eye wearable device 1 includes two retinal projection devices 10 in order to project an image onto both the right and left retinas, but may include only one of the retinal projection devices 10.

Next, the retinal projection device 10 will be described in detail with reference to FIG. 2. FIG. 2 is a configuration diagram schematically showing the retinal projection device shown in FIG. 1. As shown in FIG. 2, the retinal projection device 10 includes an optical engine 11 and a reflector 12.

The optical engine 11 is a device that generates laser light Ls having a color and light intensity corresponding to a pixel of an image to be projected onto the retina and emits the laser light Ls to the reflector 12. The optical engine 11 is mounted on the temple 2c. The optical engine 11 includes a laser module 13, optical components 14, a movable mirror 15, a laser driver 16, a mirror driver 17, and a controller 18.

The laser module 13 emits laser light. As the laser module 13, for example, a full-color laser module is used. The laser module 13 emits laser light having a color and light intensity corresponding to a pixel of an image to be projected onto the retina. Details of the laser module 13 will be described later.

The optical components 14 are components that optically process the laser light emitted from the laser module 13. In the present embodiment, the optical components 14 include a collimator lens 14a, a slit 14b, and a neutral density filter 14c. The collimator lens 14a, the slit 14b, and the neutral density filter 14c are arranged in this order along the optical path of the laser light. The optical components 14 may have other configurations.

The movable mirror 15 is a member for performing scanning with the laser light emitted from the laser module 13. The movable mirror 15 is provided in a direction in which the laser light processed by the optical components 14 is emitted. The movable mirror 15 is configured to be swingable about an axis extending in the horizontal direction of the lens 3 and about an axis extending in the vertical direction of the lens 3, for example, and reflects the laser light while changing the angle in the horizontal direction and the vertical direction of the lens 3. As the movable mirror 15, for example, a micro electro mechanical systems (MEMS) mirror is used.

The laser driver 16 is a driving circuit for driving the laser module 13. The laser driver 16 drives the laser module 13 based on, for example, the light intensity of the laser light and the temperature of a light source unit 20 included in the laser module 13. The mirror driver 17 is a driving circuit for driving the movable mirror 15. The mirror driver 17 swings the movable mirror 15 within a predetermined angle range and at a predetermined timing. The controller 18 is a device for controlling the laser driver 16 and the mirror driver 17.

In the optical engine 11, laser light having a color and light intensity corresponding to a pixel of an image to be projected onto the retina is emitted from the laser module 13, passes through the optical components 14, and is reflected by the movable mirror 15. The laser light reflected by the movable mirror 15 is emitted to the reflector 12 as the laser light Ls.

The reflector 12 is a member that projects an image onto the retina of the user wearing the near-eye wearable device 1 by reflecting the laser light Ls having passed through the movable mirror 15 and irradiating the retina with reflected light Lr. The reflector 12 is provided on the inner surface 3a of the lens 3.

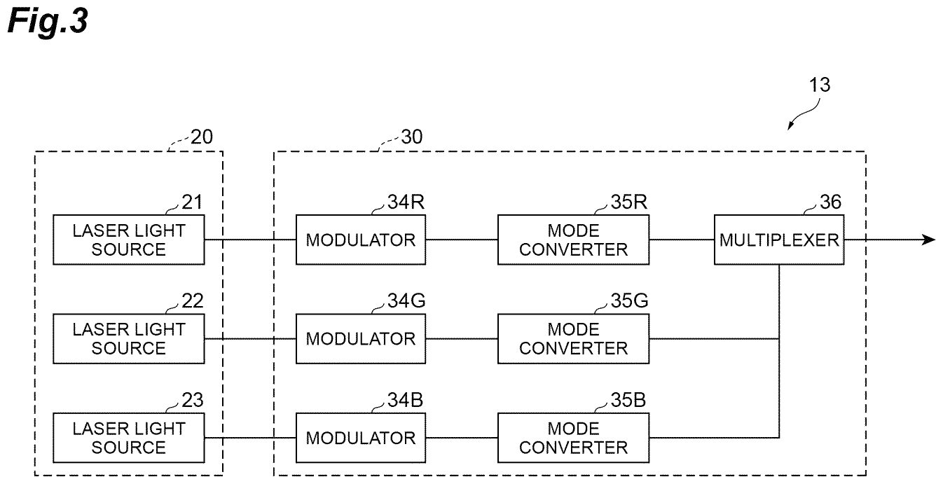

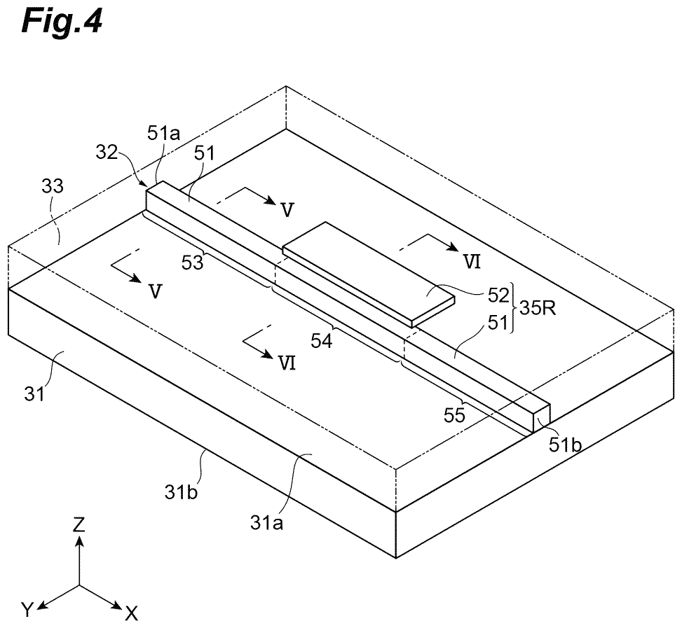

Next, the laser module 13 will be described in detail with reference to FIGS. 3 and 4. FIG. 3 is a block diagram of the laser module shown in FIG. 2. FIG. 4 is a perspective view showing the configuration of the mode converter shown in FIG. 3. FIG. 4 shows only the portion of the optical element 30, including a mode converter 35R and its surrounding area. As shown in FIG. 3, the laser module 13 includes the light source unit 20 and an optical element 30.

The light source unit 20 emits visible light. The light source unit 20 includes a laser light source 21 (first light source) for emitting red light, a laser light source 22 (second light source) for emitting green light, and a laser light source 23 (third light source) for emitting blue light. The laser light source 21 is, for example, a red laser diode. The laser light source 22 is, for example, a green laser diode. The laser light source 23 is, for example, a blue laser diode. The peak wavelength of the red light is, for example, in the range of 600 nm to 830 nm. The peak wavelength of the green light is, for example, in the range of 500 nm to 570 nm. The peak wavelength of the blue light is, for example, in the range of 380 nm to 490 nm. The laser light source 21, the laser light source 22, and the laser light source 23 are arranged in that order in the Y-axis direction.

In the present embodiment, the laser light source 21 emits red light in a TM fundamental mode (hereinafter referred to as “TM0 mode”). The laser light source 22 emits green light in the TM0 mode. The laser light source 23 emits blue light in the TM0 mode. Since the red light, the green light, and the blue light are all visible light, in the following description, the red light, the green light, and the blue light may be rephrased as each visible light, and the red light, the green light, and the blue light may be collectively referred to as visible light. The light source unit 20 may further include a subcarrier on which the laser light source 21, the laser light source 22, and the laser light source 23 are mounted.

The optical element 30 multiplexes the laser lights emitted from the respective laser light sources into one laser light. The optical element 30 is, for example, a planar lightwave circuit (PLC). The optical element 30 is bonded to the light source unit 20 through a metal bonding layer, for example. Since the laser module 13 is mounted on the near-eye wearable device 1, the size of the optical element 30 as viewed from the Z-axis direction may be 100 mm² or less. As shown in FIG. 4, the optical element 30 includes a substrate 31, a core layer 32, and a cladding layer 33.

The substrate 31 functions as a lower cladding layer. The substrate 31 is made of a material having a refractive index lower than that of the constituent material of the core layer 32. Examples of the constituent materials of the substrate 31 include sapphire, silicon oxide, and silicon laminated with silicon oxide. The substrate 31 includes a main surface 31a and a rear surface 31b opposite to the main surface 31a. The main surface 31a and the rear surface 31b are surfaces defined by the X-axis direction and the Y-axis direction, and intersect with the Z-axis direction (in the present embodiment, the main surface 31a and the rear surface 31b are orthogonal to the Z-axis direction). In other words, the X-axis direction and the Y-axis direction are directions along the main surface 31a.

The cladding layer 33 functions as an upper cladding layer. The cladding layer 33 covers the core layer 32 on the main surface 31a. The cladding layer 33 is provided over the entire surface of the main surface 31a. The cladding layer 33 is made of a material having a refractive index lower than that of the constituent material of the core layer 32. An example of a constituent material of the cladding layer 33 is silicon oxide (e.g., SiO₂).

The core layer 32 is provided on the main surface 31a. The core layer 32 is made of a material having an electro-optic effect. The electro-optic effect is a phenomenon in which the refractive index of a material is changed by applying an electric field to the material. An example of a constituent material of the core layer 32 is lithium niobate (LiNbO₃). In the present embodiment, the core layer 32 is a lithium niobate thin film formed on the main surface 31a of the substrate 31 by sputtering, and the optical axis (C-axis) of the lithium niobate extends in the Z-axis direction. The core layer 32 may be composed of Z-cut lithium niobate.

The optical element 30 includes a modulator 34R (first modulator), a modulator 34G (second modulator), a modulator 34B (third modulator), the mode converter 35R (first mode converter), a mode converter 35G (second mode converter), a mode converter 35B (third mode converter), and a multiplexer 36.

The modulator 34R is a modulator that modulates the light intensity of the red light. The modulator 34R modulates the light intensity of the red light in the TM0 mode emitted from the laser light source 21. The modulator 34G is a modulator that modulates the light intensity of the green light. The modulator 34G modulates the light intensity of the green light in the TM0 mode emitted from the laser light source 22. The modulator 34B is a modulator that modulates the light intensity of the blue light. The modulator 34B modulates the light intensity of the blue light in TM0 mode emitted from the laser light source 23. Each modulator is included in the core layer 32. Each modulator is, for example, a Mach-Zehnder modulator.

The mode converter 35R is a mode converter for converting the polarization mode of the red light from one polarization mode (first polarization mode) among the TE mode and the TM mode to the other polarization mode (second polarization mode) among the TE mode and the TM mode. In the present embodiment, the mode converter 35R converts the polarization mode of the red light from the TM0 mode to the TE fundamental mode (hereinafter referred to as “TE0 mode”). The mode converter 35R is provided subsequent to the modulator 34R and converts the polarization mode of the red light emitted from the modulator 34R from the TM0 mode to the TE0 mode.

The mode converter 35G is a mode converter for converting the polarization mode of the green light from one polarization mode (first polarization mode) among the TE mode and the TM mode to the other polarization mode (second polarization mode) among the TE mode and the TM mode. In the present embodiment, the mode converter 35G converts the polarization mode of the green light from the TM0 mode to the TE0 mode. The mode converter 35G is provided subsequent to the modulator 34G and converts the polarization mode of the green light emitted from the modulator 34G from the TM0 mode to the TE0 mode.

The mode converter 35B is a mode converter for converting the polarization mode of the blue light from one polarization mode (first polarization mode) among the TE mode and the TM mode to the other polarization mode (second polarization mode) among the TE mode and the TM mode. In the present embodiment, the mode converter 35B converts the polarization mode of the blue light from the TM0 mode to the TE0 mode. The mode converter 35B is provided subsequent to the modulator 34B and converts the polarization mode of the blue light emitted from the modulator 34B from the TM0 mode to the TE0 mode.

The polarization mode is also referred to as a waveguide mode. The TM mode is a polarization mode in which the main component of the electric field in the cross section perpendicular to the light propagation direction is oriented perpendicular to the main surface 31a of the substrate 31. The TE mode is a polarization mode in which the main component of the electric field in the cross section perpendicular to the light propagation direction is oriented parallel to the main surface 31a of the substrate 31. The TM0 mode is a polarization mode having the highest effective refractive index among the TM modes. The TE0 mode is a polarization mode having the highest effective refractive index among the TE modes.

Each of the mode converter 35R, the mode converter 35G, and the mode converter 35B extends in the X-axis direction. The mode converter 35R, the mode converter 35G, and the mode converter 35B are arranged in that order in the Y-axis direction. The detailed configuration of each mode converter will be described later.

The multiplexer 36 multiplexes the red light, the green light, and the blue light. The multiplexer 36 multiplexes the red light emitted from the mode converter 35R, the green light emitted from the mode converter 35G, and the blue light emitted from the mode converter 35B into a single laser light to emit the laser light. The laser light contains a component having a red wavelength (red component), a component having a green wavelength (green component), and a component having a blue wavelength (blue component). The multiplexer 36 is included in the core layer 32. The multiplexer 36 may be composed of a multimode interferometer (MMI), a Y-branch waveguide, or a directional coupler. The length of the multiplexer 36 in the X-axis direction may be 10 μm to 10,000 μm.

For example, the laser module 13 is manufactured by adjusting the relative position of the subcarrier of the light source unit 20 and the substrate 31 (active alignment) so that the optical axis of the visible light emitted from the laser light source aligns with the axis of the incident end of the corresponding modulator, and by bonding the light source unit 20 and the optical element 30 with a metal bonding layer.

In the laser module 13, visible light in the TM0 mode is emitted from each laser light source, the light intensity of each visible light is modulated by each modulator, and then the polarization mode of the visible light is converted from the TM0 mode to the TE0 mode by each mode converter. Then, each visible light whose polarization mode has been converted is multiplexed by the multiplexer 36 to be emitted from the multiplexer 36 to the optical components 14 (refer to FIG. 2) as laser light in the TE0 mode.

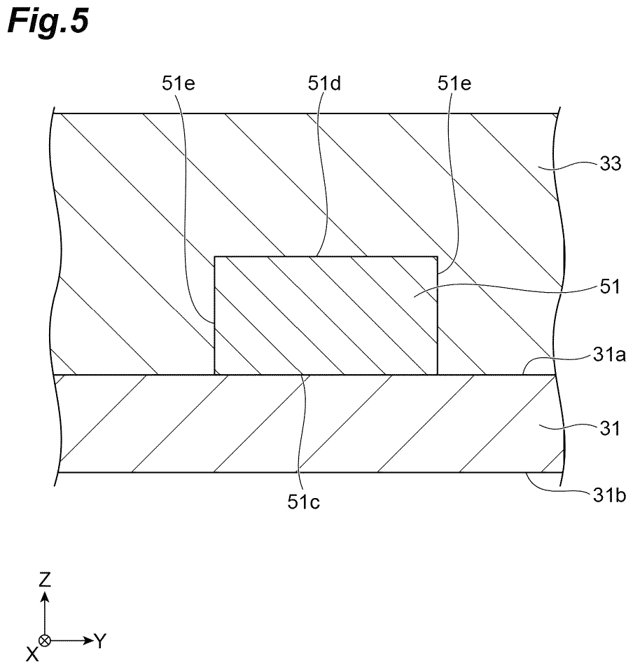

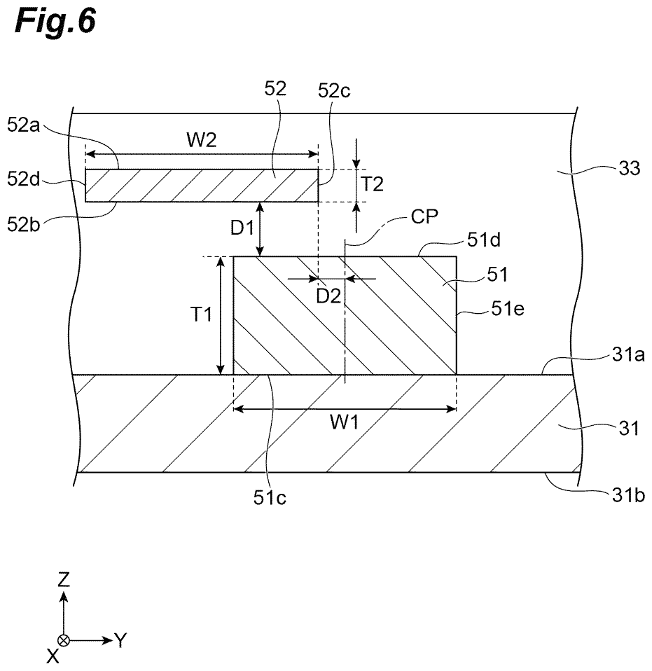

Next, the detailed configurations of the mode converter 35R, the mode converter 35G, and the mode converter 35B will be described with reference to FIGS. 4 to 6. FIG. 5 is a cross-sectional view taken along the line V-V of FIG. 4. FIG. 6 is a cross-sectional view taken along the line VI-VI of FIG. 4. In FIG. 6, hatching of the cladding layer 33 is omitted for convenience of explanation. As shown in FIG. 4, each of the mode converter 35R, the mode converter 35G, and the mode converter 35B includes a waveguide 51 and a metal body 52. Since the configuration of the mode converters is the same, the mode converter 35R will be described here as an example.

The waveguide 51 is an optical waveguide extending in the X-axis direction. The waveguide 51 is included in the core layer 32. The waveguide 51 has a columnar shape linearly extending in the X-axis direction. Specifically, the waveguide 51 has a rectangular parallelepiped shape whose longitudinal direction aligned with the X-axis direction. The waveguide 51 includes an incident end 51a, which is one end in the X-axis direction, and an emission end 51b, which is the other end in the X-axis direction. The red light in the TM0 mode is incident on the incident end 51a from the modulator 34R. The waveguide 51 emits the red light in the TE0 mode from the emission end 51b to the multiplexer 36.

The waveguide 51 is symmetric in the Z-axis direction and symmetric in the Y-axis direction. The term “symmetric in the Z-axis direction” means that, with respect to a symmetry plane that passes through the center point in the Z-axis direction and is orthogonal to the Z-axis direction, two portions separated by the symmetry plane are plane-symmetric. The term “symmetric in the Y-axis direction” means that, with respect to a plane of symmetry that passes through the center point in the Y-axis direction and is orthogonal to the Y-axis direction, two portions separated by the plane of symmetry are plane-symmetric.

As shown in FIG. 5, the waveguide 51 includes a bottom surface 51c, a top surface 51d, and a pair of side surfaces 51e. The bottom surface 51c is a surface facing the main surface 31a, and is in contact with the main surface 31a over the entire surface of the bottom surface 51c. The top surface 51d is provided opposite to the bottom surface 51c in the Z-axis direction. The bottom surface 51c and the top surface 51d are substantially parallel to each other. Each side surface 51e connects the bottom surface 51c and the top surface 51d. The pair of side surfaces 51e are substantially parallel to each other.

The length (height T1) of the waveguide 51 in the Z-axis direction and the length (width W1) thereof in the Y-axis direction are constant from the incident end 51a to the emission end 51b. Hereinafter, the length in the Z-axis direction may be referred to as “height”, and the length in the Y-axis direction may be referred to as “width”. The height T1 is smaller than the wavelength of the red light. The width W1 may be 20% to 60% or 32% to 48% of the wavelength of the red light.

The waveguide 51 includes an incident region 53, a conversion region 54, and an emission region 55. The conversion region 54 is a portion parallel to the metal body 52. The incident region 53 includes the incident end 51a and is a portion from the incident end 51a to one end of the conversion region 54. The emission region 55 includes the emission end 51b and is a portion from the other end of the conversion region 54 to the emission end 51b.

The metal body 52 is a metal member extending in the X-axis direction. The metal body 52 is provided in parallel with the waveguide 51. The metal body 52 is embedded in the cladding layer 33. That is, the periphery of the metal body 52 is covered with the cladding layer 33. The metal body 52 has a rectangular plate-like shape. The metal body 52 has a negative dielectric constant. The metal body 52 is made of, for example, a metal containing at least one element selected from the group consisting of silver (Ag), gold (Au), copper (Cu), aluminum (Al), chromium (Cr), manganese (Mn), titanium (Ti), vanadium (V), iron (Fe), cobalt (Co), nickel (Ni), zinc (Zn), molybdenum (Mo), palladium (Pd), tantalum (Ta), tungsten (W), platinum (Pt), lead (Pb), and bismuth (Bi).

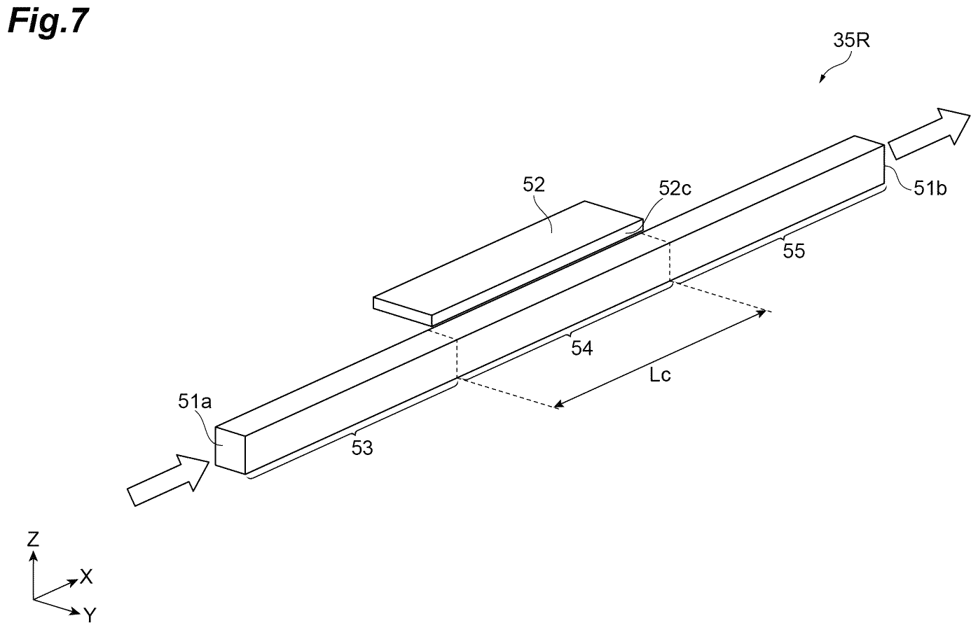

The length Lc of the metal body 52 in the X-axis direction (refer to FIG. 7) is shorter than the length of the waveguide 51 in the X-axis direction. The length Lc is, for example, 100 μm or less. The metal body 52 is positioned alongside the waveguide 51 over the entire length of the metal body 52 in the X-axis direction. In other words, the length Lc is the length of the conversion region 54 in the X-axis direction, and is also referred to as a conversion length. The height T2 and the width W2 of the metal body 52 are constant over the entire length of the metal body 52 in the X-axis direction. The height T2 is, for example, 1 nm to 200 nm. The width W2 is, for example, 10 nm to 1 μm.

As shown in FIG. 6, the metal body 52 includes a main surface 52a and a main surface 52b. The main surface 52b is a surface facing the main surface 31a. The main surface 52b faces the top surface 51d, and the main surface 52b and the top surface 51d are substantially parallel to each other. The main surface 52a is provided opposite to the main surface 52b in the Z-axis direction. The metal body 52 includes an edge 52c, which is one edge in the Y-axis direction, and an edge 52d, which is the other edge in the Y-axis direction. When viewed from the Z-axis direction, the edge 52c overlaps the waveguide 51, and the edge 52d does not overlap the waveguide 51.

The distance D1 in the Z-axis direction between the waveguide 51 (top surface 51d) and the metal body 52 is, for example, 0 nm or more. That is, the metal body 52 is disposed such that the edge 52c, the top surface 51d, and the bottom surface 51c are arranged in this order in the Z-axis direction. The distance D1 from the top surface 51d in the direction opposite to the bottom surface 51c is expressed as a positive value, and the distance D1 from the top surface 51d toward the bottom surface 51c is expressed as a negative value. The distance D2 in the Y-axis direction between the center CP of the waveguide 51 in the Y-axis direction and the edge 52c is, for example, 0 nm or more and half or less of the width W1. In other words, the metal body 52 covers half or less of the top surface 51d in the conversion region 54. The distance D2 from the center CP in the direction toward the side surface 51e close to the edge 52d of the pair of side surfaces 51e is expressed as a positive value, and the distance D2 from the center CP in the direction away from the side surface 51e close to the edge 52d of the pair of side surfaces 51e is expressed as a negative value.

The mode converter 35G and the mode converter 35B have the same configuration as the mode converter 35R, but the optimal dimensions may be different for each of the mode converter 35R, the mode converter 35G, and the mode converter 35B. The optimum dimension referred to herein is an optimum dimension in order to maximize the conversion efficiency of the polarization mode of each visible light. The height of the waveguide 51 of the mode converter 35R, the height of the waveguide 51 of the mode converter 35G, and the height of the waveguide 51 of the mode converter 35B are substantially equal to each other. The height of the waveguide 51 of the mode converter 35R, the height of the waveguide 51 of the mode converter 35G, and the height of the waveguide 51 of the mode converter 35B may be different from each other.

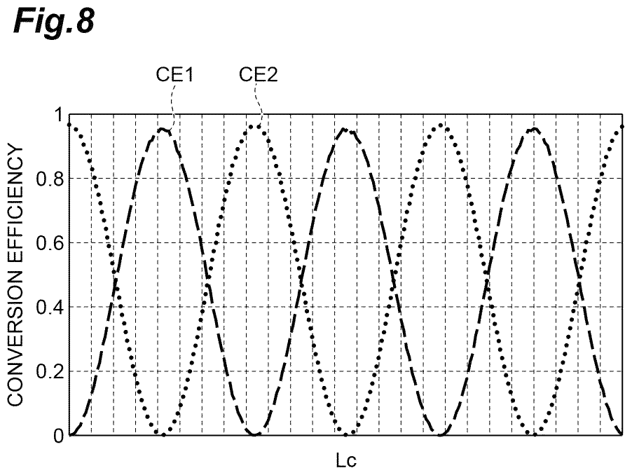

Next, the conversion principles in the mode converter 35R, the mode converter 35G, and the mode converter 35B will be described with reference to FIGS. 7 and 8. FIG. 7 is a diagram for explaining the conversion principle of the mode converter shown in FIG. 4. FIG. 8 is a graph showing an example of the conversion efficiency in the mode converter shown in FIG. 4. The horizontal axis of FIG. 8 indicates the length Lc, and the vertical axis of FIG. 8 indicates the conversion efficiency. Since the operation of the mode converters is the same, the mode converter 35R will be described here as an example.

As shown in FIG. 7, the mode converter 35R converts the polarization mode of the red light in the TM0 mode incident on the incident end 51a from the TM0 mode to the TE0 mode, and emits the red light in the TE0 mode from the emission end 51b. In the incident region 53, since the polarization mode of the red light is the TM0 mode, the vector of the electric field component is parallel to the Z-axis direction. When the red light is incident on the conversion region 54, the polarization mode of the red light interacts with the surface plasmons generated on the surface of the metal body 52, and rotates in accordance with the position of the edge 52c of the metal body 52. As a result, two mixed modes (first mixed mode and second mixed mode) in which the TE mode and the TM mode are mixed are excited as the polarization mode of the red light.

At this time, the electric field components in the horizontal direction in the first mixed mode and the electric field components in the horizontal direction in the second mixed mode change in accordance with the position of the edge 52c of the metal body 52. In the present embodiment, the position of the edge 52c is adjusted so that the electric field components in the horizontal direction and the electric field components in the vertical direction in the first mixed mode are substantially the same, and the electric field components in the horizontal direction and the electric field components in the vertical direction in the second mixed mode are substantially the same. The electric field vector in the first mixed mode is orthogonal to the electric field vector in the second mixed mode.

In the conversion region 54, since there is a difference between the propagation constant β₁ of the first mixed mode and the propagation constant β₂ of the second mixed mode, a phase difference occurs between the phase of the first mixed mode and the phase of the second mixed mode in accordance with the length that the red light propagates through the conversion region 54. When the red light propagates from the emission end of the conversion region 54 to the emission region 55, the first mixed mode and the second mixed mode are coupled into a single polarization mode. At this time, when the phase difference is π×(2n+1) (n is an integer of 0 or more) radian, the polarization mode of the red light is rotated by 90° from the TM0 mode to be converted into the TE0 mode.

As shown in FIG. 8, the conversion efficiency CE1 and the conversion efficiency CE2 periodically change in accordance with the magnitude of the length Lc. The conversion efficiency CE1 indicates the conversion efficiency when the red light in the TM0 mode is incident on the incident end 51a and the red light in the TE0 mode is emitted from the emission end 51b. The conversion efficiency CE2 indicates the conversion efficiency when the red light in the TM0 mode is incident on the incident end 51a and the red light in the TM0 mode is emitted from the emission end 51b. The conversion efficiency represents the light intensity of the emitted light when the light intensity of the incident light is set to 1. The conversion efficiency CE1 and the conversion efficiency CE2 periodically oscillate as the length Lc increases, and the maximum value of the conversion efficiency CE1 and the maximum value of the conversion efficiency CE2 alternately appear at each half cycle.

In the present embodiment, since the mode converter 35R converts the red light in the TM0 mode into the red light in the TE0 mode, the length Lc is set to a length at which the conversion efficiency CE1 takes a maximum value. Since the length Lc is the shortest when the phase difference between the phase of the first mixed mode and the phase of the second mixed mode is π radian, the length Lc is obtained by dividing the π radian by the difference between the propagation constant β₁ and the propagation constant β₂ as shown in Equation (1). Further, the length Lc is calculated by the right side of Equation (1) when the above equation is modified using the effective refractive index n_{eff1} of the first mixed mode, the effective refractive index n_{eff2} of the second mixed mode, and the vacuum wave number k₀.

$$[ Equation 1 ]$$

$$Lc = \frac{π}{{β}_{1} - {β}_{2}} = \frac{π}{( {n}_{eff 1} - {n}_{eff 2} ) \times {k}_{0}} \qquad ( 1 )$$

Since the vacuum wave number k₀ is expressed by 2π/λ, Equation (2) is obtained from Equation (1).

$$[ Equation 2 ]$$

$$Lc = \frac{λ}{2 \times ( {n}_{eff 1} - {n}_{eff 2} )} \qquad ( 2 )$$

The conversion efficiency (CE) in the mode converter is expressed by Equation (3) using the rotation angle φ, the length Lc, and the length L_{π}. The unit of CE in Equation (3) is %. The tangent of the rotation angle φ is expressed by Equation (4) using the dielectric constant distribution ε(y,z), the electric field component Ey(y,z) of the mixed mode in the horizontal direction, and the electric field component Ez(y,z) of the mixed mode in the vertical direction.

$$[ Equation 3 ]$$

$$C E = {sin}^{2} ( 2 φ ) {sin}^{2} ( \frac{π Lc}{2 {L}_{π}} ) \times 100 \qquad ( 3 )$$

$$[ Equation 4 ]$$

$$tan ( φ ) = \frac{\int {\int }_{Ω} ε ( y , z ) \cdot {E}_{y}^{2} ( y , z ) dydz}{\int {\int }_{Ω} ε ( y , z ) \cdot {E}_{z}^{2} ( y , z ) dydz} \qquad ( 4 )$$

The rotation angle φ is a rotation angle between the optical axis of the mixed mode and a plane parallel to the main surface 31a of the substrate 31. The length L_{π} is a length at which the phase difference between the first mixed mode and the second mixed mode is π radian. According to Equation (3), a conversion efficiency close to 100% is obtained when the rotation angle φ is 45°. According to Equation (4), when the electric field component Ey(y,z) in the horizontal direction and the electric field component Ez(y,z) in the vertical direction are equal in the first mixed mode and the second mixed mode, the rotation angle φ is 45°. From the above, when the electric field component Ey(y,z) in the horizontal direction and the electric field component Ez(y,z) in the vertical direction are equal in the first mixed mode and the second mixed mode, the conversion efficiency close to 100% can be obtained.

In the conversion region 54, propagation loss occurs due to the imaginary part of the effective refractive index of each polarization mode. The imaginary part nᵢ of the effective refractive index is caused by light absorption by the metal body 52. The propagation loss TL is expressed by Equation (5) using the imaginary part nᵢ and the wavelength λ.

$$[ Equation 5 ]$$

$$TL = {n}_{i} \times \frac{4 π}{λ} \qquad ( 5 )$$

As shown in Equation (5), since the propagation loss TL is inversely proportional to the wavelength λ, the propagation loss TL tends to increase as the wavelength λ decreases. Since the propagation loss TL is proportional to the imaginary part nᵢ, the propagation loss TL can be suppressed by reducing the imaginary part nᵢ.

In the laser module 13 and the optical element 30 described above, the waveguide 51 and the metal body 52 are provided in parallel, and the edge 52c of the metal body 52 overlaps the waveguide 51 when viewed from the Z-axis direction. Since the metal body 52 has a negative dielectric constant, surface plasmons are excited on the surface of the metal body 52. Therefore, the polarization mode of the visible light propagating through the waveguide 51 interacts with the surface plasmons, and is rotated in accordance with the position of the edge 52c of the metal body 52. As a result, the first mixed mode and the second mixed mode in which the TE mode and the TM mode are mixed can be generated in the portion (conversion region 54) of the waveguide 51 parallel to the metal body 52. In the conversion region 54, since there is a difference between the propagation constant of the first mixed mode and the propagation constant of the second mixed mode, a phase difference occurs between the phase of the first mixed mode and the phase of the second mixed mode in accordance with the length Lc of the conversion region 54 in the X-axis direction. When the visible light is emitted from the conversion region 54, the first mixed mode and the second mixed mode are coupled into a single polarization mode, and the polarization mode of the visible light can be converted from the TM0 mode to the TE0 mode. As described above, according to the laser module 13 and the optical element 30, the polarization mode of the visible light can be converted.

The near-eye wearable device 1 includes the retinal projection device 10, and the retinal projection device 10 includes the optical element 30. Accordingly, in the near-eye wearable device 1 and the retinal projection device 10, it is possible to project an image onto the retina after converting the polarization mode of the visible light from the TM0 mode to the TE0 mode.

In the laser module 13 and the optical element 30, the metal body 52 is embedded in the cladding layer 33. In this configuration, the surface plasmon is a localized mode of an electromagnetic wave confined in a direction perpendicular to the interface between the metal body 52 and the cladding layer 33, and propagates through the interface. By changing the relative position of the waveguide 51 and the metal body 52, the characteristics of the surface plasmon, particularly the interaction with the visible light propagating through the waveguide 51, can be adjusted. Accordingly, the optical axis rotation of the polarization mode of the visible light propagating through the waveguide 51 is likely to occur.

When the distance D1 is 0 nm or more, the rotation angle φ can be made close to 45°, so that the conversion efficiency can be improved. When the distance D2 is 0 nm or more and half or less of the width W1, the rotation angle φ can be made close to 45°, so that the conversion efficiency can be improved.

Specifically, in the mode converter 35R, when the distance D1 is 0nm to 100 nm and the distance D2 is 0 nm to 90 nm, the rotation angle φ can be made close to 45°, so that the conversion efficiency can be improved. In the mode converter 35G, when the distance D1 is 0 nm to 40 nm and the distance D2 is 20 nm to 80 nm, the rotation angle φ can be made close to 45°, so that the conversion efficiency can be improved. In the mode converter 35B, when the distance D1 is 0 nm to 10 nm and the distance D2 is 10 nm to 70 nm, the rotation angle φ can be made close to 45°, so that the conversion efficiency can be improved.

The imaginary part nᵢ of the effective refractive index is caused by light absorption by the metal body 52, but when the length Lc is 30 μm or less, the influence of the imaginary part n; on the propagation loss is small. Accordingly, the propagation loss TL is suppressed. From the above, it is possible to reduce the conversion loss occurring throughout each mode converter.

The metal body 52 is made of, for example, a metal containing at least one element selected from the group consisting of silver, gold, copper, aluminum, chromium, manganese, titanium, vanadium, iron, cobalt, nickel, zinc, molybdenum, palladium, tantalum, tungsten, platinum, lead, and bismuth.

The multiplexer 36 is designed such that the multiplexing efficiency in the case of multiplexing the red light, the green light, and the blue light in the TE0 mode is higher than the multiplexing efficiency in the case of multiplexing the red light, the green light, and the blue light in the TM0 mode. In the optical element 30, the mode converter 35R converts the polarization mode of the red light from the TM0 mode to the TE0 mode, the mode converter 35G converts the polarization mode of the green light from the TM0 mode to the TE0 mode, and the mode converter 35B converts the polarization mode of the blue light from the TM0 mode to the TE0 mode. Accordingly, the multiplexing efficiency in the multiplexer 36 can be improved.

The height of the waveguide 51 of the mode converter 35R, the height of the waveguide 51 of the mode converter 35G, and the height of the waveguide 51 of the mode converter 35B are the same as each other. According to this configuration, the waveguide 51 of the mode converter 35R, the waveguide 51 of the mode converter 35G, and the waveguide 51 of the mode converter 35B can be formed on the same substrate 31, and the height of each of the waveguides 51 can be made the same, so that the optical element 30 can be easily manufactured.

In order to output full-color laser light by multiplexing the red light, the green light, and the blue light, it is necessary to adjust the light intensity of light of each color corresponding to the output color. In order to change the light intensity of each color light in the light source unit 20, a large drive current is required. In the optical element 30, the light intensity of the red light is modulated (voltage-modulated) by the modulator 34R, the light intensity of the green light is modulated (voltage-modulated) by the modulator 34G, and the light intensity of the blue light is modulated (voltage-modulated) by the modulator 34B. Accordingly, full-color laser light can be output without requiring a large drive current.

The modulation in the light source unit 20 and the modulation in the modulators 34R, 34G, and 34B may be used in combination. In general, adjustment by voltage is more responsive than adjustment by electric current. Accordingly, in the case where the response is emphasized, the light intensity of each color may be roughly adjusted in the light source unit 20 and the light intensity of each color may be finely adjusted in the modulators 34R, 34G, and 34B. Since fine adjustment by electric current can reduce the amount of electric current, electric power consumption can be reduced. Accordingly, in the case where reducing electric power consumption is emphasized, the light intensities of the respective colors may be roughly adjusted in the modulators 34R, 34G, and 34B, and the light intensities of the respective colors may be finely adjusted in the light source unit 20.

In the polarization rotator described in Non-Patent Document 1, the lower cladding is made of InP and the core is made of InGaAsP. In this case, since the difference in refractive index between the lower cladding and the core is small, a longer conversion length is required. In the compound semiconductor, materials selectable as the lower cladding and the core are limited, so that the difference in refractive index between the lower cladding and the core cannot be increased. On the other hand, in the optical element 30, for example, the substrate 31 is made of sapphire, the cladding layer 33 is made of silicon dioxide, and the core layer 32 is made of lithium niobate. In this case, the difference in refractive index between the cladding layer and the core layer 32 can be increased. Accordingly, the length Lc can be reduced.

The incident end 51a and the emission end 51b of the waveguide 51 in each mode converter may be interchanged. Specifically, the mode converter 35R may convert the polarization mode of the red light in the TM0 mode incident on the emission end 51b from the TM0 mode to the TE0 mode, and may emit the red light in the TE0 mode from the incident end 51a. The mode converter 35G may convert the polarization mode of the green light in the TM0 mode incident on the emission end 51b from the TM0 mode to the TE0 mode, and may emit the green light in the TE0 mode from the incident end 51a. The mode converter 35B may convert the polarization mode of the blue light in the TM0 mode incident on the emission end 51b from the TM0 mode to the TE0 mode, and may emit the blue light in the TE0 mode from the incident end 51a.

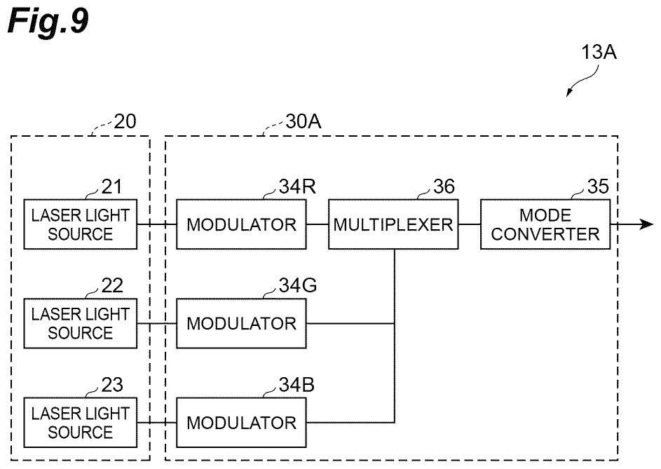

Next, a laser module according to another embodiment will be described with reference to FIG. 9. FIG. 9 is a block diagram of a laser module according to another embodiment. The laser module 13A shown in FIG. 9 is mainly different from the laser module 13 in that the laser module 13A includes an optical element 30A instead of the optical element 30. The optical element 30A is mainly different from the optical element 30 in that the optical element 30A includes one mode converter 35 instead of the mode converter 35R, the mode converter 35G, and the mode converter 35B, and that the multiplexer 36 is disposed between each of the modulators and the mode converter 35.

Specifically, the multiplexer 36 is provided subsequent to the modulators 34R, 34G, and 34B, and multiplexes the red light emitted from the modulator 34R, the green light emitted from the modulator 34G, and the blue light emitted from the modulator 34B. The multiplexer 36 emits the multiplexed laser light to the mode converter 35.

The mode converter 35 is provided subsequent to the multiplexer 36, and converts the polarization mode of the laser light emitted from the multiplexer 36 from the TM0 mode to the TE0 mode. The configuration of the mode converter 35 is the same as that of the mode converter 35R.

In the laser module 13A, visible light in the TM0 mode is emitted from each laser light source, and the light intensity of the visible light in the TM0 mode is modulated by each modulator. The visible light modulated by each modulator is multiplexed by the multiplexer 36 to generate laser light. Then, the polarization mode of the laser light is converted from the TM0 mode to the TE0 mode by the mode converter 35, and the laser light in the TE0 mode is emitted from the mode converter 35 to the optical components 14 (refer to FIG. 2).

Also in the laser module 13A, the same effects as those of the laser module 13 can be obtained in the configuration common to the laser module 13. Also in the optical element 30A, the same effects as those of the optical element 30 can be obtained in the configuration common to the optical element 30. Since the laser module 13A and the optical element 30A include one mode converter 35 instead of the mode converter 35R, the mode converter 35G, and the mode converter 35B, the laser module 13A and the optical element 30A can be reduced in size.

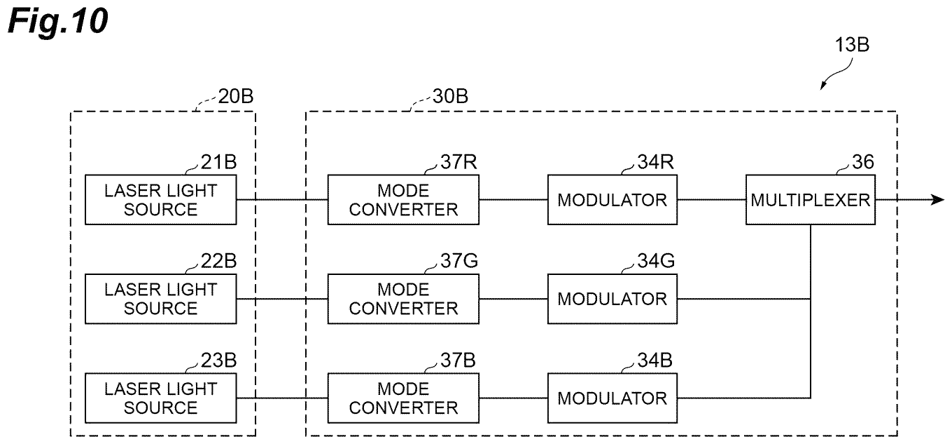

Next, a laser module according to still another embodiment will be described with reference to FIG. 10. FIG. 10 is a block diagram of a laser module according to still another embodiment. The laser module 13B is mainly different from the laser module 13 in that the laser module 13B includes a light source unit 20B and an optical element 30B instead of the light source unit 20 and the optical element 30. The light source unit 20B is mainly different from the light source unit 20 in that the light source unit 20B includes laser light sources 21B, 22B, and 23B instead of the laser light sources 21, 22, and 23.

The laser light sources 21B, 22B, and 23B are mainly different from the laser light source 21, 22, and 23 in the polarization mode of the visible light to be emitted. Specifically, the laser light source 21B emits red light in the TE0 mode. The laser light source 22B emits green light in the TE0 mode. The laser light source 23B emits blue light in the TE0 mode.

The optical element 30B is mainly different from the optical element 30 in that the optical element 30B includes the mode converters 37R, 37G, and 37B instead of the mode converters 35R, 35G, and 35B.

The mode converter 37R is a mode converter for converting the polarization mode of the red light from the TE0 mode (first polarization mode) to the TM0 mode (second polarization mode). The mode converter 37R converts the polarization mode of the red light emitted from the laser light source 21B from the TE0 mode to the TM0 mode, and emits the red light in the TM0 mode to the modulator 34R.

The mode converter 37G is a mode converter for converting the polarization mode of the green light from the TE0 mode (first polarization mode) to the TM0 mode (second polarization mode). The mode converter 37G converts the polarization mode of the green light emitted from the laser light source 22B from the TE0 mode to the TM0 mode, and emits the green light in the TM0 mode to the modulator 34G.

The mode converter 37B is a mode converter for converting the polarization mode of the blue light from the TE0 mode (first polarization mode) to the TM0 mode (second polarization mode). The mode converter 37B converts the polarization mode of the blue light emitted from the laser light source 23B from the TE0 mode to the TM0 mode, and emits the blue light in the TM0 mode to the modulator 34B. As the mode converters 37R, 37G, and 37B, mode converters having the same structure as that of the mode converters 35R, 35G, and 35B are used, respectively.

The modulator 34R is provided subsequent to the mode converter 37R, modulates the light intensity of the red light in the TM0 mode emitted from the mode converter 37R, and emits the modulated red light to the multiplexer 36. The modulator 34G is provided subsequent to the mode converter 37G, modulates the light intensity of the green light in the TM0 mode emitted from the mode converter 37G, and emits the modulated green light to the multiplexer 36. The modulator 34B is provided subsequent to the mode converter 37B, modulates the light intensity of the blue light in the TM0 mode emitted from the mode converter 37B, and emits the modulated blue light to the multiplexer 36. As described above, the C-axis of the lithium niobate extends in the Z-axis direction. Accordingly, the modulation efficiency of each modulator is improved in the TM mode.

In the laser module 13B, since the visible light in the TE0 mode is emitted from each laser light source, the polarization mode of each visible light emitted from each laser light source is converted from the TE0 mode to the TM0 mode by each mode converter. Then, after the light intensity of the visible light in the TM0 mode is modulated by each modulator, the modulated visible light is multiplexed by the multiplexer 36 to be emitted from the multiplexer 36 to the optical components 14 (refer to FIG. 2) as the laser light in the TM0 mode.

Also in the laser module 13B, the same effects as those of the laser module 13 can be obtained in the configuration common to the laser module 13. Also in the optical element 30B, the same effects as those of the optical element 30 can be obtained in the configuration common to the optical element 30. In the laser module 13B and the optical element 30B, the visible light in the TE0 mode is emitted from each of the laser light sources. Even in this case, the polarization mode of the visible light can be converted from the TE0 mode to the TM0 mode without lowering the modulation efficiency of each modulator, and the visible light in the TM0 mode can be emitted to the outside.

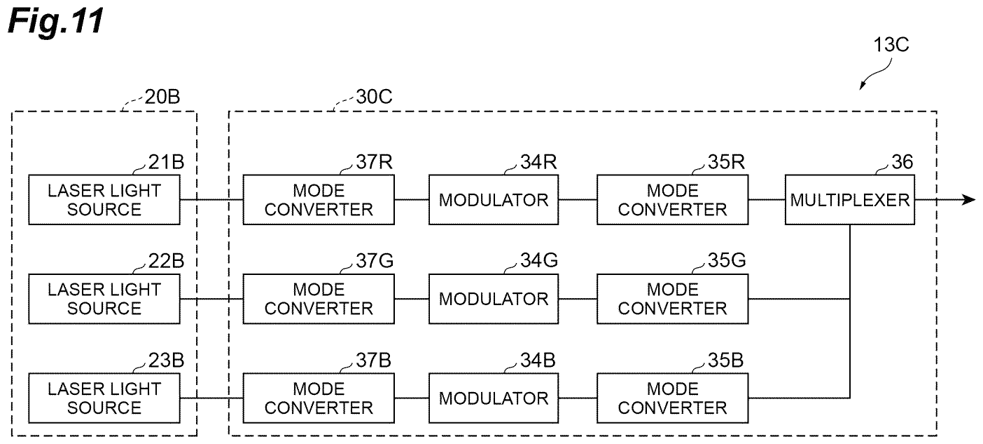

Next, a laser module according to still another embodiment will be described with reference to FIG. 11. FIG. 11 is a block diagram of a laser module according to still another embodiment. The laser module 13C shown in FIG. 11 is mainly different from the laser module 13B in that the laser module 13C includes an optical element 30C instead of the optical element 30B. The optical element 30C is mainly different from the optical element 30B in that the optical element 30C further includes the mode converter 35R, the mode converter 35G, and the mode converter 35B.

The mode converter 35R is provided subsequent to the modulator 34R. The mode converter 35R converts the polarization mode of the red light emitted from the modulator 34R from the TM0 mode to the TE0 mode, and emits the red light in the TE0 mode to the multiplexer 36. The mode converter 35G is provided subsequent to the modulator 34G. The mode converter 35G converts the polarization mode of the green light emitted from the modulator 34G from the TM0 mode to the TE0 mode, and emits the green light in the TE0 mode to the multiplexer 36. The mode converter 35B is provided subsequent to the modulator 34B. The mode converter 35B converts the polarization mode of the blue light emitted from the modulator 34B from the TM0 mode to the TE0 mode, and emits the blue light in the TE0 mode to the multiplexer 36.

In the laser module 13C, since the visible light in the TE0 mode is emitted from each laser light source, first, the polarization mode of each visible light emitted from each laser light source is converted from the TE0 mode to the TM0 mode by the mode converters 37R, 37G, and 37B. Then, after the light intensity of the visible light in the TM0 mode is modulated by each modulator, the polarization mode of each of the modulated visible light is converted from the TM0 mode to the TE0 mode by each of the mode converters 35R, 35G, and 35B. Then, each visible light is multiplexed by the multiplexer 36 to be emitted from the multiplexer 36 to the optical components 14 (refer to FIG. 2) as the laser light in the TE0 mode.

Also in the laser module 13C, the same effects as those of the laser module 13B can be obtained in the configuration common to the laser module 13B. Also in the optical element 30C, the same effects as those of the optical element 30B can be obtained in the configuration common to the optical element 30B. In the laser module 13C and the optical element 30C, the visible light in the TE0 mode is emitted from each of the laser light sources. Even in this case, the visible light in the TE0 mode can be emitted to the outside without lowering the modulation efficiency of each modulator.

The optical element, the laser module, the retinal projection device, and the near-eye wearable device according to the present disclosure are not limited to the above-described embodiments.

For example, each of the laser modules 13, 13A, 13B, and 13C may be applied to devices other than the near-eye wearable device 1.

The optical elements 30, 30A, 30B, and 30C are not required to include the cladding layer 33. In this case, the air layer can function as the upper cladding layer.

The optical elements 30, 30A, 30B, and 30C only need to include one mode converter. In other words, the optical elements 30, 30A, 30B, and 30C only need to include one mode converter for converting the polarization mode of the visible light from one polarization mode among the TE mode and the TM mode to the other polarization mode among the TE mode and the TM mode.

The laser module 13 may include the light source unit 20B in place of the light source unit 20. In this case, the optical element 30 includes the mode converters 37R, 37G, and 37B instead of the mode converters 35R, 35G, and 35B. The visible light in the TE0 mode is incident on each modulator. In order to improve the modulation efficiency in each modulator, the core layer 32 may be made of X-cut lithium niobate, and the optical axis (C-axis) of the lithium niobate may extend in the Y-axis direction. According to this configuration, the visible light in the TE0 mode is emitted from each laser light source, the light intensity of each visible light is modulated by each modulator, and then the polarization mode of the visible light is converted from the TE0 mode to the TM0 mode by each mode converter. Then, the respective visible lights whose polarization modes have been converted are multiplexed by the multiplexer 36 to be emitted from the multiplexer 36 to the optical components 14 (refer to FIG. 2) as the laser light in the TM0 mode.

Similarly, the laser module 13A may include the light source unit 20B instead of the light source unit 20. In this case, the optical element 30A includes, instead of the mode converter 35, a mode converter for converting the polarization mode of the visible light from the TE0 mode to the TM0 mode. The core layer 32 may be made of X-cut lithium niobate, and the optical axis (C-axis) of the lithium niobate may extend in the Y-axis direction. According to this configuration, the visible light in the TE0 mode is emitted from each laser light source, and the light intensity of the visible light in the TE0 mode is modulated by each modulator. The visible light modulated by each modulator is multiplexed by the multiplexer 36 to generate laser light. Then, the polarization mode of the laser light is converted from the TE0 mode to the TM0 mode by the mode converter, and the laser light in the TM0 mode is emitted from the mode converter to the optical components 14 (refer to FIG. 2).

The laser module 13B may include the light source unit 20 instead of the light source unit 20B. In this case, the optical element 30B includes the mode converters 35R, 35G, and 35B instead of the mode converters 37R, 37G, and 37B. The core layer 32 may be made of X-cut lithium niobate, and the optical axis (C-axis) of the lithium niobate may extend in the Y-axis direction. According to this configuration, since the visible light in the TM0 mode is emitted from each laser light source, the polarization mode of each visible light emitted from each laser light source is converted from the TM0 mode to the TE0 mode by each mode converter. Then, after the light intensity of the visible light in the TE0 mode is modulated by each modulator, the modulated visible light is multiplexed by the multiplexer 36 to be emitted from the multiplexer 36 to the optical components 14 (refer to FIG. 2) as the laser light in the TE0 mode.

The laser module 13C may include the light source unit 20 instead of the light source unit 20B. In this case, in the optical element 30C, the mode converters 35R, 35G, and 35B are interchanged with the mode converters 37R, 37G, and 37B. The core layer 32 may be made of X-cut lithium niobate, and the optical axis (C-axis) of the lithium niobate may extend in the Y-axis direction. Since the visible light in the TM0 mode is emitted from each laser light source, the polarization mode of each visible light emitted from each laser light source is first converted from the TM0 mode to the TE0 mode by each of the mode converters 35R, 35G, and 35B. Then, after the light intensity of the visible light in the TE0 mode is modulated by each modulator, the polarization mode of each modulated visible light is converted from the TE0 mode to the TM0 mode by each of the mode converters 37R, 37G, and 37B. Then, each visible light is multiplexed by the multiplexer 36 to be emitted from the multiplexer 36 to the optical components 14 (refer to FIG. 2) as the laser light in the TM0 mode.

### EXAMPLES

Hereinafter, the present disclosure will be described in more detail with reference to Examples in order to explain the above effects. The present disclosure is not limited to these examples.

### Evaluation of Conversion Loss for Light of Each Color

The conversion losses in the mode converters of Examples 1 to 3were calculated. The conversion loss here means a loss in the conversion from the TM0 mode to the TE0 mode. As the mode converters of Examples 1 to 3, mode converters having the same structure as that of the mode converter 35R shown in FIGS. 4 to 6 were used. In Examples 1 to 3, sapphire was used as the constituent material of the substrate 31, Z-cut lithium niobate (LiNbO₃) was used as the constituent material of the core layer 32, silicon dioxide (SiO₂) was used as the constituent material of the cladding layer 33, and silver (Ag) was used as the constituent material of the metal body 52.

As shown in Table 1, in Examples 1 to 3, the values of the respective parameters were set so as to maximize the conversion efficiency.

TABLE 1

| | | | | | | | | | | | Conversion |
|---|---|---|---|---|---|---|---|---|---|---|---|
| | | λ | T1 | W1 | T2 | W2 | D1 | D2 | Lc | Conversion | Loss |
| | Color | [nm] | [μm] | [μm] | [μm] | [μm] | [μm] | [μm] | [μm] | Efficiency | [dB] |
| Example 1 | red | 638 | 0.25 | 0.20 | 0.02 | 0.40 | 0.05 | 0.04 | 16.0 | 0.758 | 1.20 |
| Example 2 | green | 520 | 0.18 | 0.16 | 0.02 | 0.40 | 0.00 | 0.06 | 11.0 | 0.772 | 1.12 |
| Example 3 | blue | 455 | 0.20 | 0.15 | 0.02 | 0.40 | 0.00 | 0.06 | 22.0 | 0.563 | 2.50 |

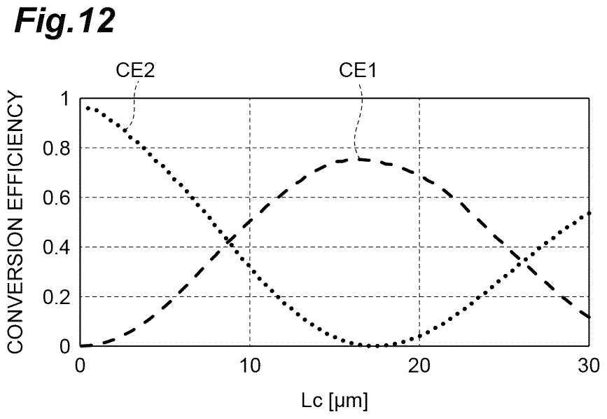

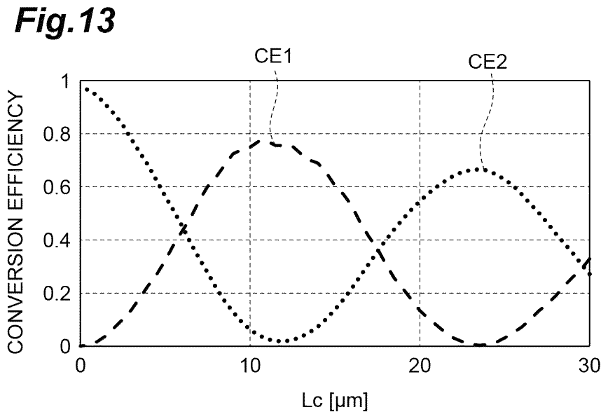

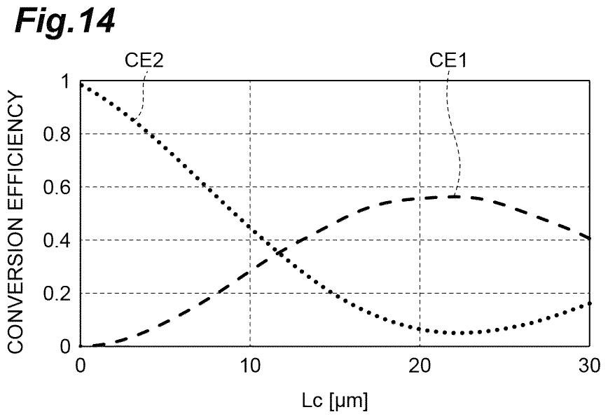

In the mode converters of Examples 1 to 3, the conversion efficiency was calculated while changing the magnitude of the length Lc. The calculation results are shown in FIGS. 12 to 14. FIG. 12 is a diagram showing the relationship between the conversion length and the conversion efficiency in the mode converter of Example 1. FIG. 13 is a diagram showing the relationship between the conversion length and the conversion efficiency in the mode converter of Example 2. FIG. 14 is a diagram showing the relationship between the conversion length and the conversion efficiency in the mode converter of Example 3. The horizontal axes in FIGS. 12 to 14 indicate the length Lc (conversion length) (unit: μm), and the vertical axes in FIGS. 12 to 14 indicate the conversion efficiency.

In the mode converter of Example 1, the electric field components in the horizontal direction in the first mixed mode were about 49% of the entire field in the first mixed mode. The electric field components in the horizontal direction in the second mixed mode were about 50% of the entire field in the second mixed mode. In this case, the conversion efficiencies CE1 and CE2 shown in FIG. 12 were obtained, and the length Lc was calculated to be 16.0 μm. When the length Lc was 16.0 μm, the conversion efficiency at the time of conversion from the TM0 mode to the TE0 mode was 0.758, and the conversion loss was 1.20 dB.

In the mode converter of Example 2, the electric field components in the horizontal direction in the first mixed mode were about 43% of the entire field in the first mixed mode. The electric field components in the horizontal direction in the second mixed mode were about 56% of the entire field in the second mixed mode. In this case, the conversion efficiencies CE1 and CE2 shown in FIG. 13 were obtained, and the length Lc was calculated to be 11.0 μm. When the length Lc was 11.0 μm, the conversion efficiency at the time of conversion from the TM0 mode to the TE0 mode was 0.772, and the conversion loss was 1.12 dB.

In the mode converter of Example 3, the electric field components in the horizontal direction in the first mixed mode were about 38% of the entire field in the first mixed mode. The electric field components in the horizontal direction in the second mixed mode were about 62% of the entire field in the second mixed mode. In this case, the conversion efficiencies CE1 and CE2 shown in FIG. 14 were obtained, and the length Lc was calculated to be 22.0 μm. When the length Lc was 22.0 μm, the conversion efficiency at the time of conversion from the TM0 mode to the TE0 mode was 0.563, and the conversion loss was 2.50 dB.

In the mode converters of Examples 1 to 3, a relatively small conversion loss of 1.12 dB to 2.50 dB occurred. The length Lc was 11.0 μm to 22.0 μm. From these, it can be understood that low-loss mode conversion is achieved with the shortening of the length Lc.

### Evaluation of Distance D1 and Distance D2

The influence of distance D1 and distance D2 on the conversion loss was evaluated. For this evaluation, the mode converters of Examples 1 to 3 were used. The values of the parameters (wavelength λ, height T1, width W1, height T2, and width W2) other than the distance D1 and the distance D2 were set to the values shown in Table 1. The length Lc was set to a length of 100 μm or less, which maximizes the conversion efficiency for each parameter value.

For red light, the conversion loss was calculated for each of the distances D1 of 0 nm, 20 nm, 40 nm, 60 nm, 80 nm, and 100 nm while changing the distance D2. For green light, the conversion loss was calculated for each of the distances D1 of 0 nm, 10 nm, 20 nm, 30 nm, 40 nm, 50 nm, and 60 nm while changing the distance D2. For blue light, the conversion loss was calculated for each of the distances D1 of 0 nm, 10 nm, 20 nm, 30 nm, 40 nm, and 60 nm while changing the distance D2. These conversion losses are losses in the conversion from the TM0 mode to the TE0 mode.

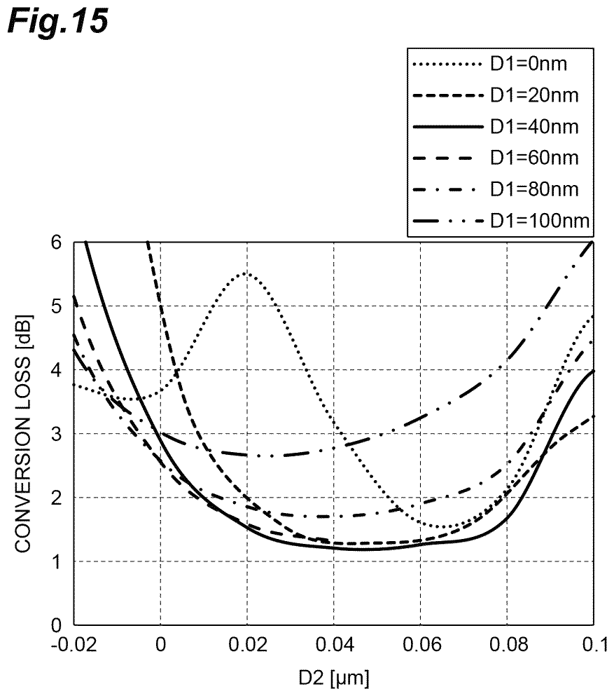

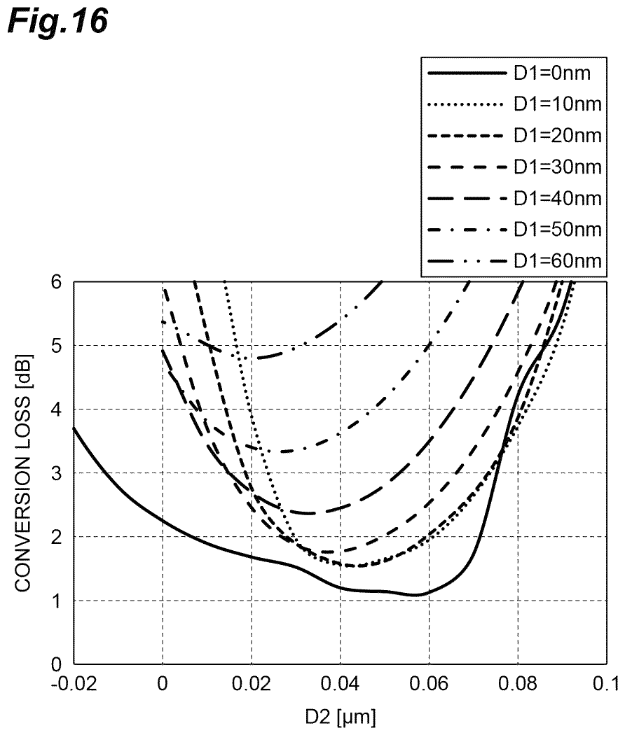

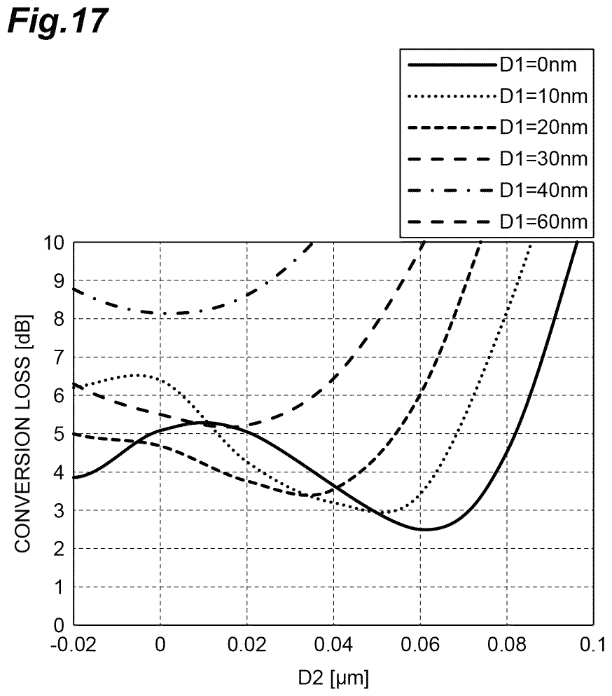

The calculation results of the conversion loss are shown in FIGS. 15 to 17. FIG. 15 is a diagram showing calculation results of conversion loss of red light. FIG. 16 is a diagram showing calculation results of conversion loss of green light. FIG. 17 is a diagram showing calculation results of conversion loss of blue light. The horizontal axes in FIGS. 15 to 17 indicate the distance D2 (unit: μm), and the vertical axes in FIGS. 15 to 17 indicate the conversion loss (unit: dB).

From the viewpoint that the output light of the laser light source (laser diode) can be suppressed to a low level, it is determined that high conversion efficiency is achieved when the conversion loss is 6 dB or less. According to FIG. 15, when the distance D1 is 0 nm to 100 nm and the distance D2 is 0 nm to 90 nm, the conversion loss of the red light is 6 dB or less. Accordingly, it can be understood that a high conversion efficiency is achieved when the distance D1 is 0 nm to 100 nm and the distance D2 is 0 nm to 90 nm.

According to FIG. 16, when the distance D1 is 0 nm to 40 nm and the distance D2 is 20 nm to 80 nm, the conversion loss of the green light is 6 dB or less. Accordingly, it can be understood that a high conversion efficiency is achieved when the distance D1 is 0 nm to 40 nm and the distance D2 is 20 nm to 80 nm. According to FIG. 17, when the distance D1 is 0 nm to 10 nm and the distance D2 is 10 nm to 70 nm, the conversion loss of the blue light is 6 dB or less. Accordingly, it can be understood that a high conversion efficiency is achieved when the distance D1 is 0 nm to 10 nm and the distance D2 is 10 nm to 70 nm.

The allowable value of the conversion loss also depends on the loss tolerated by the entire system and the breakdown of the chip losses (the coupling efficiency between the laser diode and the waveguide end face of the chip in which the optical element is integrated, and the component loss of the conversion loss in the optical circuit in the chip).

### Evaluation of Distance D1

The influence of distance D1 on the conversion loss was evaluated. For this evaluation, the mode converters of Examples 1 to 3 were used. The values of the parameters (wavelength λ, height T1, width W1, height T2, and width W2) other than the distance D1 and the distance D2 were set to the values shown in Table 1. The length Lc was set to a length of 100 μm or less, which maximizes the conversion efficiency for each parameter value.

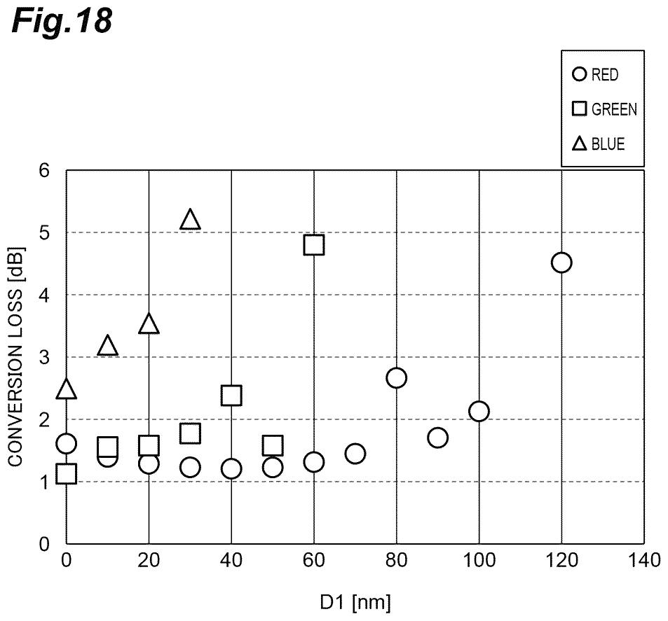

At each distance D1, the conversion loss was calculated when the distance D2 was changed by 10 nm in the range of −20 nm to 100 nm. This conversion loss is a loss in the conversion from the TM0 mode to the TE0 mode. The calculation results of the conversion loss are shown in FIG. 18. FIG. 18 is a diagram showing the relationship between the distance between the waveguide and the metal body in the Z-axis direction and the conversion loss. The horizontal axis of FIG. 18 indicates the distance D1 (unit: nm), and the vertical axis of FIG. 18 indicates the conversion loss (unit: dB). FIG. 18 shows the minimum value of the conversion loss at each distance D1.

From the viewpoint that the output light of the laser light source (laser diode) can be suppressed to a low level, it is determined that high conversion efficiency is achieved when the conversion loss is 6 dB or less. According to FIG. 18, when the distance D1 is 0 nm to 120 nm, the conversion loss of the red light is 6 dB or less. Accordingly, it can be understood that a high conversion efficiency is achieved when the distance D1 is 0 nm to 120 nm. According to FIG. 18, when the distance D1 is 0 nm to 60 nm, the conversion loss of the green light is 6 dB or less. Accordingly, it can be understood that a high conversion efficiency is achieved when the distance D1 is 0 nm to 60 nm. According to FIG. 18, when the distance D1 is 0 nm to 30 nm, the conversion loss of the blue light is 6 dB or less. Accordingly, it can be understood that a high conversion efficiency is achieved when the distance D1 is 0 nm to 30 nm. It can be understood that the smaller the distance D1, the smaller the conversion loss.

### ADDITIONAL STATEMENTS

### Clause 1

An optical element comprising:
a substrate including a main surface;
a core layer provided on the main surface and made of a material having an electro-optic effect, the core layer including a waveguide extending in a first direction along the main surface; and
a metal body extending in the first direction and provided in parallel with the waveguide,
wherein the waveguide and the metal body constitute a mode converter configured to convert a polarization mode of visible light from a first polarization mode, which is one polarization mode among a TE mode and a TM mode, to a second polarization mode, which is another polarization mode among the TE mode and the TM mode,
wherein the waveguide includes an incident end on which the visible light in the first polarization mode is incident and an emission end from which the visible light in the second polarization mode is emitted,
wherein the metal body includes an edge in a second direction intersecting the first direction and along the main surface, and
wherein the edge overlaps the waveguide when viewed from a third direction intersecting the main surface.

### Clause 2

The optical element according to clause 1,
wherein the waveguide includes a bottom surface facing the main surface and a top surface provided opposite to the bottom surface in the third direction, and
wherein the metal body is disposed such that the edge, the top surface, and the bottom surface are arranged in that order in the third direction.

### Clause 3

The optical element according to clause 1 or 2,
wherein a distance in the second direction between a center of the waveguide in the second direction and the edge is 0 nm or more and half or less of a length of the waveguide in the second direction.

### Clause 4

The optical element according to any one of clauses 1 to 3,
wherein the metal body is made of a metal containing at least one element selected from a group consisting of silver, gold, copper, aluminum, chromium, manganese, titanium, vanadium, iron, cobalt, nickel, zinc, molybdenum, palladium, tantalum, tungsten, platinum, lead, and bismuth.

### Clause 5

The optical element according to any one of clauses 1 to 4, comprising:
a first mode converter which is the mode converter configured to convert a polarization mode of red light from the first polarization mode to the second polarization mode;
a second mode converter which is the mode converter configured to convert a polarization mode of green light from the first polarization mode to the second polarization mode;
a third mode converter which is the mode converter configured to convert a polarization mode of blue light from the first polarization mode to the second polarization mode; and
a multiplexer configured to multiplex the red light, the green light, and the blue light to emit laser light.

### Clause 6

The optical element according to clause 5,
wherein a length of the waveguide of the first mode converter in the third direction, a length of the waveguide of the second mode converter in the third direction, and a length of the waveguide of the third mode converter in the third direction are equal to each other.

### Clause 7

The optical element according to clause 5 or 6, further comprising:
a first modulator configured to modulate light intensity of the red light;
a second modulator configured to modulate light intensity of the green light; and
a third modulator configured to modulate light intensity of the blue light.

### Clause 8

A laser module comprising:
the optical element according to any one of clauses 5 to 7;
a first light source configured to emit the red light in the first polarization mode;
a second light source configured to emit the green light in the first polarization mode; and
a third light source configured to emit the blue light in the first polarization mode.

### Clause 9

A retinal projection device mounted on a near-eye wearable device, the retinal projection device comprising:
the laser module according to clause 8;
a movable mirror configured to perform scanning with the laser light emitted from the laser module; and
a reflector configured to project an image onto a retina of a user wearing the near-eye wearable device by reflecting the laser light having passed through the movable mirror and irradiating the retina with reflected light.

### Clause 10

A near-eye wearable device comprising:
the retinal projection device according to clause 9; and
a lens provided with the reflector.

What is claimed is:

1. An optical element comprising:
a substrate including a main surface;
a core layer provided on the main surface and made of a material having an electro-optic effect, the core layer including a waveguide extending in a first direction along the main surface; and
a metal body extending in the first direction and provided in parallel with the waveguide,
wherein the waveguide and the metal body constitute a mode converter configured to convert a polarization mode of visible light from a first polarization mode, which is one polarization mode among a TE mode and a TM mode, to a second polarization mode, which is another polarization mode among the TE mode and the TM mode,
wherein the waveguide includes an incident end on which the visible light in the first polarization mode is incident and an emission end from which the visible light in the second polarization mode is emitted,
wherein the metal body includes an edge in a second direction intersecting the first direction and along the main surface, and
wherein the edge overlaps the waveguide when viewed from a third direction intersecting the main surface.

2. The optical element according to claim 1,
wherein the waveguide includes a bottom surface facing the main surface and a top surface provided opposite to the bottom surface in the third direction, and
wherein the metal body is disposed such that the edge, the top surface, and the bottom surface are arranged in that order in the third direction.

3. The optical element according to claim 1,
wherein a distance in the second direction between a center of the waveguide in the second direction and the edge is 0 nm or more and half or less of a length of the waveguide in the second direction.

4. The optical element according to claim 1,
wherein the metal body is made of a metal containing at least one element selected from a group consisting of silver, gold, copper, aluminum, chromium, manganese, titanium, vanadium, iron, cobalt, nickel, zinc, molybdenum, palladium, tantalum, tungsten, platinum, lead, and bismuth.

5. The optical element according to claim 1, comprising:
a first mode converter which is the mode converter configured to convert a polarization mode of red light from the first polarization mode to the second polarization mode;
a second mode converter which is the mode converter configured to convert a polarization mode of green light from the first polarization mode to the second polarization mode;
a third mode converter which is the mode converter configured to convert a polarization mode of blue light from the first polarization mode to the second polarization mode; and
a multiplexer configured to multiplex the red light, the green light, and the blue light to emit laser light.

6. The optical element according to claim 5,
wherein a length of the waveguide of the first mode converter in the third direction, a length of the waveguide of the second mode converter in the third direction, and a length of the waveguide of the third mode converter in the third direction are equal to each other.

7. The optical element according to claim 5, further comprising:
a first modulator configured to modulate light intensity of the red light;
a second modulator configured to modulate light intensity of the green light; and
a third modulator configured to modulate light intensity of the blue light.

8. A laser module comprising:
the optical element according to claim 5;
a first light source configured to emit the red light in the first polarization mode;
a second light source configured to emit the green light in the first polarization mode; and
a third light source configured to emit the blue light in the first polarization mode.

9. A retinal projection device mounted on a near-eye wearable device, the retinal projection device comprising:
the laser module according to claim 8;
a movable mirror configured to perform scanning with the laser light emitted from the laser module; and
a reflector configured to project an image onto a retina of a user wearing the near-eye wearable device by reflecting the laser light having passed through the movable mirror and irradiating the retina with reflected light.

10. A near-eye wearable device comprising:
the retinal projection device according to claim 9; and
a lens provided with the reflector.
